(19) United States
(12) Patent Application Publication
(10) Pub. No.: US 2021/0240499 A1
(43) Pub. Date: Aug. 5, 2021

(54) SYSTEMS AND METHODS FOR ADJUSTING APPLICATION FUNCTIONALITY TO RESOURCE CONSTRAINTS

(71) Applicant: Netflix, Inc., Los Gatos, CA (US)

(72) Inventors: Shyamsundar Gopalakrishnan, San Jose, CA (US); Chethan Suresh, Santa Clara, CA (US); Maria Bronkie, Campbell, CA (US); Ben Johnson, San Jose, CA (US); Amritanshu Thakur, San Jose, CA (US); Michael Galassi, San Jose, CA (US); Christopher Steger, San Francisco, CA (US); Tom Richards, Los Gatos, CA (US); Sam Pan, Los Gatos, CA (US)

(21) Appl. No.: 16/779,265

(22) Filed: Jan. 31, 2020

(51) Int. Cl. G06F 9/451; G06F 9/48

(52) U.S. Cl. CPC G06F 9/451; G06F 2209/485; G06F 9/4881

(57) ABSTRACT

The disclosed computer-implemented method may include identifying an application, on an electronic device, with a minimum requirement for a resource of the electronic device. The method may also include determining that an available amount of the resource of the electronic device does not meet the minimum requirement of the application. Additionally, the method may include selecting, based on the determination, an alternative user-interface mode of the application with a lower minimum requirement for the resource. Furthermore, the method may include instantiating the alternative user-interface mode of the application. Various other methods, systems, and computer-readable media are also disclosed.

### BACKGROUND

Software applications can enhance the use of computing devices by providing additional functionality to users. Applications that run on a device often use the resources of the device, such as the device's processing power or digital memory. Some applications require a minimum amount of certain computing resources in order to properly function. For example, a video streaming application may require a certain amount of network bandwidth or speed to properly display videos.

However, when a computing device is unable to provide the minimum resources required by an application, whether due to a lack of resources or competing use by other applications, the functionality of the application may suffer. In the example of the video streaming application, a low bandwidth network connection may cause the application to lag or stutter while playing videos. If another application, such as a music streaming application, is currently running, it may utilize a portion of the network bandwidth, thereby decreasing the bandwidth available to the video streaming application. These types of resource constraints may reduce the functionality of important features of an application, which may greatly decrease the user experience of the application.

### SUMMARY

As will be described in greater detail below, the present disclosure describes systems and methods for adjusting the functionality of an application based on resource constraints. In one example, a computer-implemented method for adjusting application functionality to resource constraints may include identifying an application, on an electronic device, with a minimum requirement for a resource of the electronic device. The method may also include determining that an available amount of the resource of the electronic device does not meet the minimum requirement of the application. Additionally, the method may include selecting, based on the determination, an alternative user-interface mode of the application with a lower minimum requirement for the resource. Furthermore, the method may include instantiating the alternative user-interface mode of the application.

In some embodiments, the resource of the electronic device may include a memory of the electronic device and/or a processing capacity of the electronic device. Additionally or alternatively, the resource may include a network connection.

In one example, determining that the available amount of the resource does not meet the minimum requirement may include determining that the minimum requirement exceeds a total capacity of the resource. Additionally or alternatively, determining that the available amount of the resource does not meet the minimum requirement may include determining that the minimum requirement exceeds an unused portion of the resource.

In one embodiment, the alternative user-interface mode may include a mode prioritizing a function of the application to enable reducing a usage of the resource and/or deferring the usage of the resource. In this embodiment, selecting the alternative user-interface mode of the application may include selecting the mode based on a type of the resource that does not meet the minimum requirement. Additionally, in some embodiments, prioritizing the function of the application may include optimizing a search speed, simplifying rendering of a user-interface element, decreasing a quality of a streaming element, decreasing a processing footprint on the electronic device, decreasing a memory footprint on the electronic device, decreasing network usage, and/or delaying a non-essential component of the application. In these embodiments, optimizing the search speed may include reducing a number of predictive search results and/or reducing automation of a search completion function. Furthermore, in these embodiments, simplifying rendering of a user-interface element may include decreasing a size of the user-interface element, reducing an amount of detail presented in the user-interface element, and/or deferring rendering of the user-interface element.

In some examples, instantiating the alternative user-interface mode of the application may include initiating the application in the alternative user-interface mode. Additionally or alternatively, instantiating the alternative user-interface mode may include transitioning to the alternative user-interface mode based on determining that a decrease in the available amount of the resource does not meet the minimum requirement of the application.

In some embodiments, the above method may further include determining that the available amount of the resource of the electronic device meets the minimum requirement of the application and instantiating a standard user-interface mode of the application based on the determination. In these embodiments, the standard user-interface mode may include a mode capable of maximizing a function of the application by increasing a usage of the resource and/or resuming the usage of the resource. Additionally, instantiating the standard user-interface mode of the application may include initiating the application in the standard user-interface mode and/or transitioning to the standard user-interface mode based on determining that an increase in the available amount of the resource meets the minimum requirement of the application.

In one example, the above method may further include determining an available amount of a different resource of the electronic device does not meet a minimum requirement for the different resource. In this example, the above method may also include transitioning to a different alternative user-interface mode of the application with a lower minimum requirement for the different resource.

In addition, a corresponding system for adjusting application functionality to resource constraints may include several modules stored in memory, including an identification module that identifies an application, on an electronic device, with a minimum requirement for a resource of the electronic device. The system may also include a determination module that determines that an available amount of the resource of the electronic device does not meet the minimum requirement of the application. Additionally, the system may include a selection module that selects, based on the determination, an alternative user-interface mode of the application with a lower minimum requirement for the resource. Furthermore, the system may include an instantiation module that instantiates the alternative user-interface mode of the application. Finally, the system may include one or more processors that execute the identification module, the determination module, the selection module, and the instantiation module.

In some embodiments, the selection module may select the alternative user-interface mode of the application based on a user preference for a function of the application. In one embodiment, the selection module may further select the alternative user-interface mode to fulfill minimum requirements of the application for multiple resources of the electronic device.

In one example, the selection module may request confirmation for the alternative user-interface mode from a user of the electronic device and receive a response from the user. In this example, the response from the user may include a confirmation of the alternative user-interface mode or a rejection of the alternative user-interface mode. Furthermore, the selection module may select a different alternative user-interface mode of the application based on the rejection of the alternative user-interface mode.

In some examples, the above-described method may be encoded as computer-readable instructions on a computer-readable medium. For example, a computer-readable medium may include one or more computer-executable instructions that, when executed by at least one processor of a computing device, may cause the computing device to identify an application, on an electronic device, with a minimum requirement for a resource of the electronic device. The instructions may also cause the computing device to determine that an available amount of the resource of the electronic device does not meet the minimum requirement of the application. Additionally, the instructions may cause the computing device to select, based on the determination, an alternative user-interface mode of the application with a lower minimum requirement for the resource. Finally, the instructions may cause the computing device to instantiate the alternative user-interface mode of the application.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a block diagram of an exemplary content distribution ecosystem.

FIG. 2 is a block diagram of an exemplary distribution infrastructure within the content distribution ecosystem shown in FIG. 1.

FIG. 3 is a block diagram of an exemplary content player within the content distribution ecosystem shown in FIG. 1.

FIG. 4 a flow diagram of an exemplary method for adjusting application functionality to resource constraints.

FIG. 5 is a block diagram of an exemplary system with an exemplary electronic device for adjusting application functionality to resource constraints.

FIG. 6 is a block diagram of an exemplary selection of an alternative user-interface mode based on available exemplary resources.

FIG. 7 illustrates an exemplary transition to an alternative user-interface mode prioritizing an exemplary search function.

FIG. 8 illustrates an exemplary transition to a standard user-interface mode maximizing graphical user-interface rendering.

FIG. 9 is a block diagram of an exemplary selection of a different alternative user-interface mode based on a user response.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to adjusting the functionality of an application based on current resource constraints. As will be explained in greater detail below, embodiments of the present disclosure may, by limiting less important features or elements of an application, improve the functionality of important features when resources are constrained. The disclosed systems and methods may first determine that an application's standard minimum requirement for a resource is not met by the available resources of an electronic device. The disclosed systems and methods may then identify an alternative user-interface mode that limits the use of the constrained resource. For example, the disclosed systems and methods may determine that a network connection does not have the bandwidth to stream video in a standard video player but that an alternative video player with a smaller size could stream the video at a lower resolution, thereby requiring less bandwidth. By finding an alternative mode that requires less of the constrained resource, the systems and methods described herein may prioritize more important functions of the application and enable the application to run despite the resource constraints. For example, the systems and methods described herein may determine that the ability to stream the video is more important than keeping a larger video player and switch to the smaller size whenever the network bandwidth is limited. Additionally, when resources increase or satisfy the minimum requirements, the disclosed systems and methods may then revert to the standard mode to maximize the capabilities of the application.

Traditionally, applications may have included two separate versions, one for higher resource availability and one for constrained resources. For example, the video player described above may have had a standard application version and an application for devices with lower resources. Users may then have needed to select the application that is appropriate for their devices. However, resources may be temporarily constrained, such as when other applications are also using the same network, which may cause malfunctions if a device runs the higher-resource version of the application. Additionally, if a device's resources are upgraded, the lower-resource version of the application may not provide all the features the electronic device is capable of supporting. By enabling the selection of different modes within a single application, the disclosed systems and methods may enable the application to determine the most appropriate mode based on current resources. Furthermore, by enabling switching between application modes, the disclosed systems and methods may dynamically select the appropriate mode when changes to resource constraints are detected.

The systems and methods described herein may improve the functioning of a computing device by improving the functionality of software applications running on the computing device based on the limitations of the computing device's resources. For example, improvements to the functionality of an application may include both perceived improvements due to an alternative user experience with the application as well as technical improvements due to more efficient management of resources. In addition, these systems and methods may also improve the field of resource management by identifying current resources constraints and modifying applications to fit the constraints. Finally, by containing multiple user-interface modes within an application, these systems and methods may improve the field of software versioning to enable dynamic adjustments to a single version of the application. Thus, the disclosed systems and methods may improve over traditional methods of running “lite” versions of software applications.

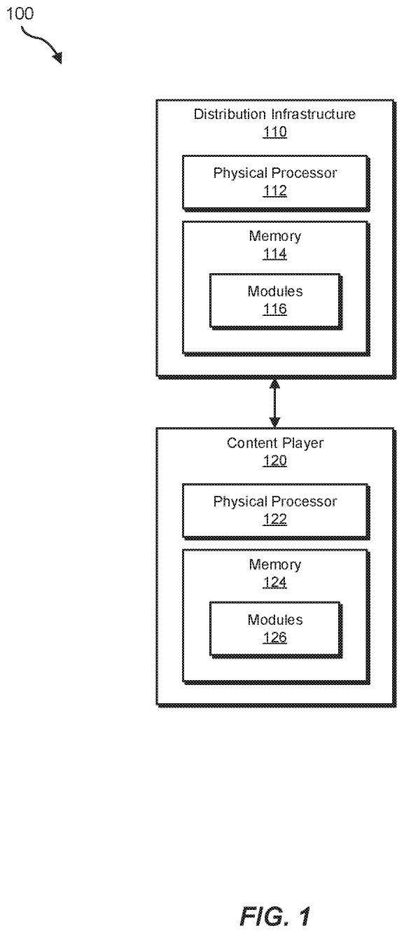

Because many of the embodiments described herein may be used with substantially any type of computing network, including distributed networks designed to provide video content to a worldwide audience, various computer network and video distribution systems will initially be described with reference to FIGS. 1-3. These figures will introduce the various networks and distribution methods used to provision video content to users.

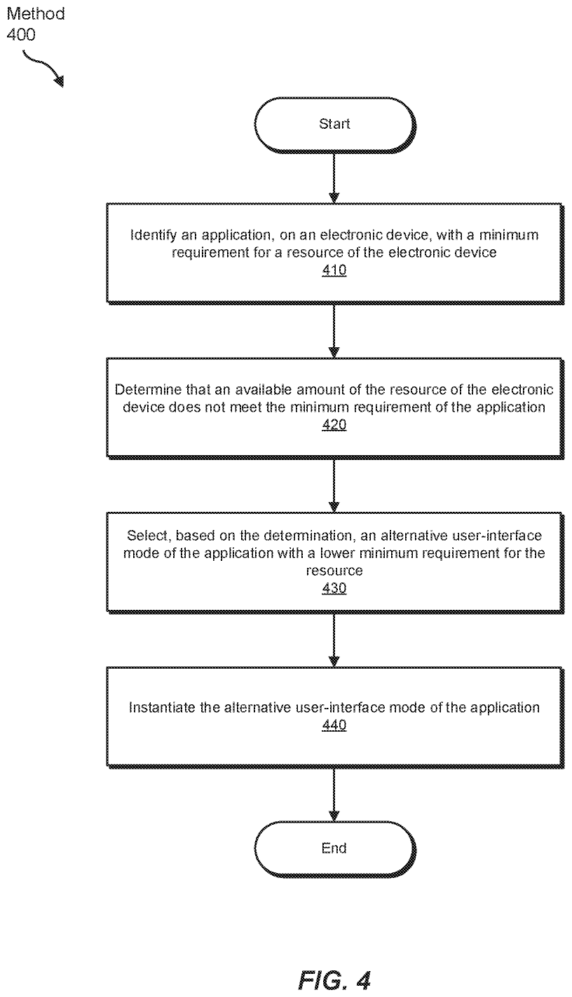

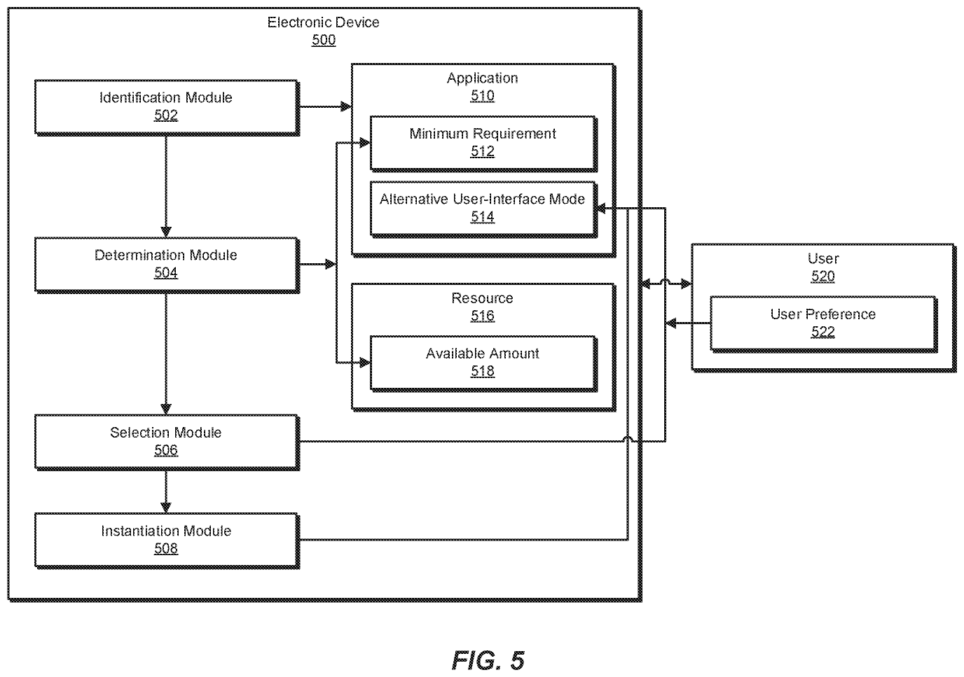

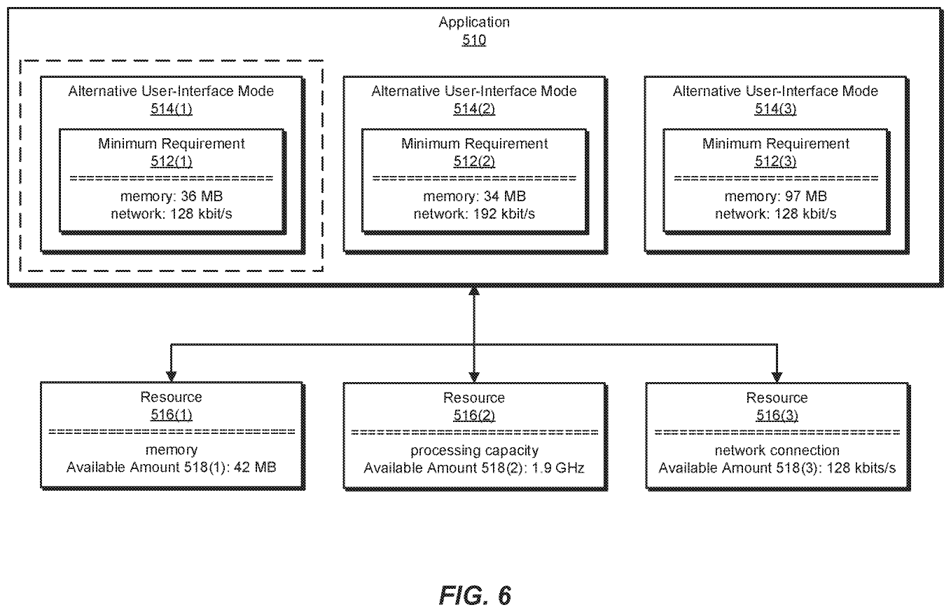

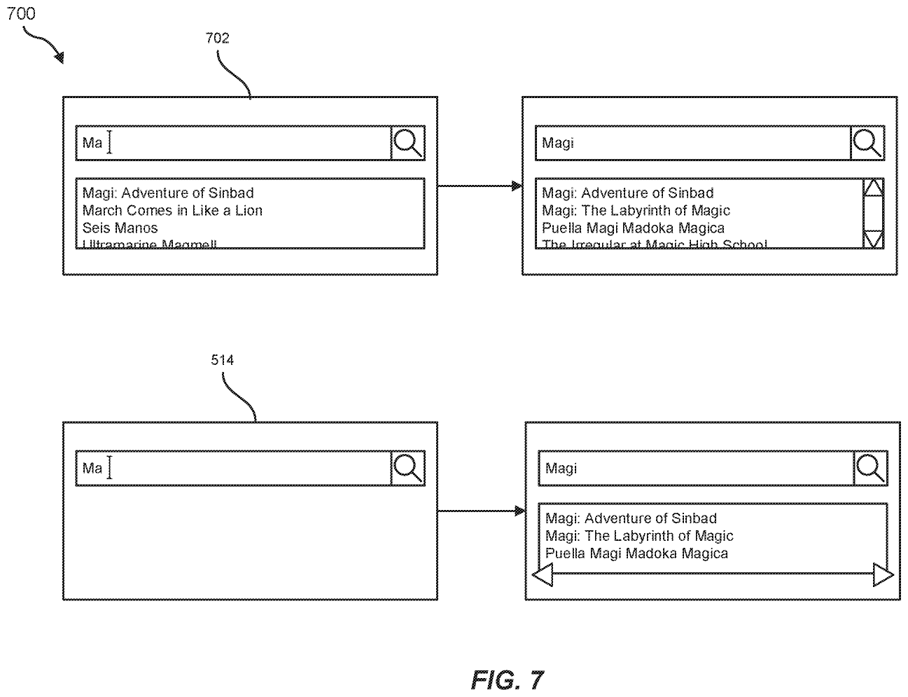

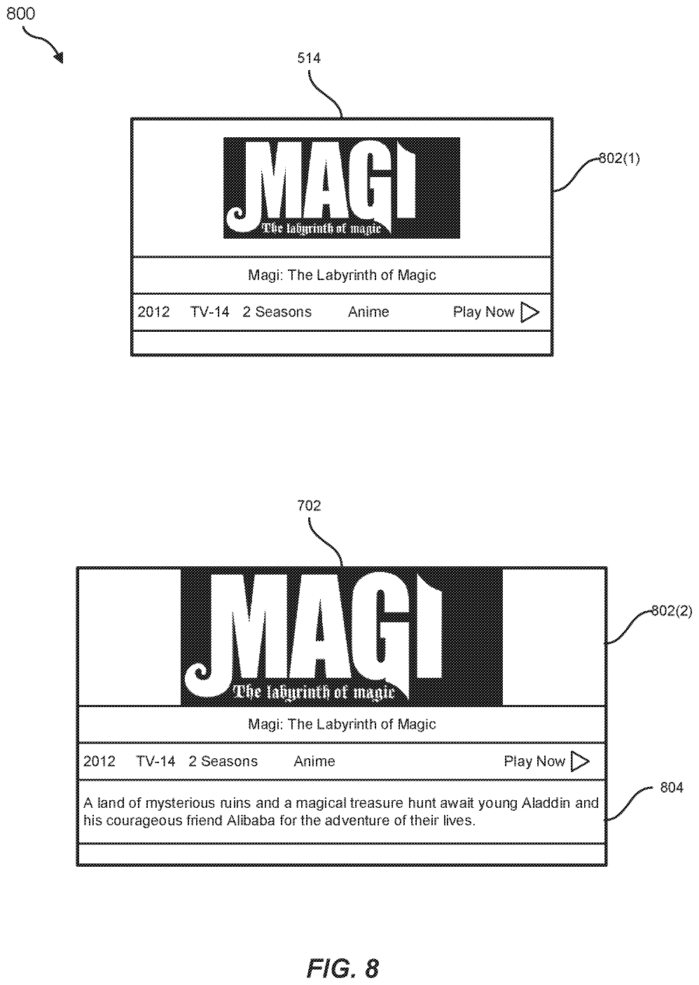

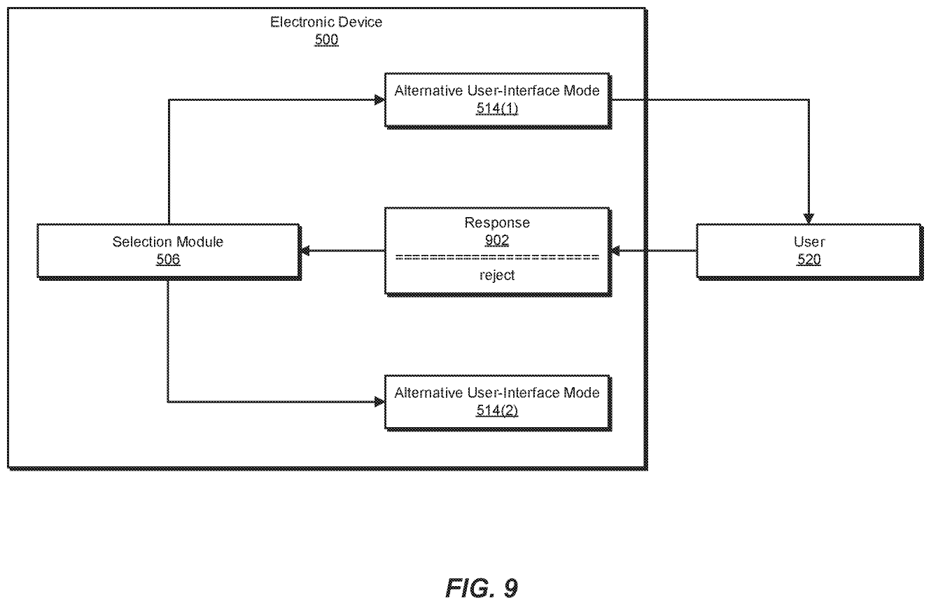

Thereafter, the description will provide, with reference to FIG. 4, detailed descriptions of computer-implemented methods for adjusting application functionality to resource constraints. Detailed descriptions of a corresponding exemplary system will be provided in connection with FIG. 5. Detailed descriptions of an exemplary selection of an alternative user-interface mode based on available exemplary resources will be provided in connection with FIG. 6. In addition, detailed descriptions of an exemplary transition to an alternative user-interface mode prioritizing an exemplary search function will be provided in connection with FIG. 7. Next, detailed descriptions of an exemplary transition to a standard user-interface mode maximizing graphical user-interface rendering will be provided in connection with FIG. 8. Detailed descriptions of an exemplary selection of a different alternative user-interface mode based on a user response will then be provided in connection with FIG. 9.

FIG. 1 is a block diagram of a content distribution ecosystem 100 that includes a distribution infrastructure 110 in communication with a content player 120. In some embodiments, distribution infrastructure 110 may be configured to encode data and to transfer the encoded data to content player 120 via data packets. Content player 120 may be configured to receive the encoded data via distribution infrastructure 110 and to decode the data for playback to a user. The data provided by distribution infrastructure 110 may include audio, video, text, images, animations, interactive content, haptic data, virtual or augmented reality data, location data, gaming data, or any other type of data that may be provided via streaming.

Distribution infrastructure 110 generally represents any services, hardware, software, or other infrastructure components configured to deliver content to end users. For example, distribution infrastructure 110 may include content aggregation systems, media transcoding and packaging services, network components (e.g., network adapters), and/or a variety of other types of hardware and software. Distribution infrastructure 110 may be implemented as a highly complex distribution system, a single media server or device, or anything in between. In some examples, regardless of size or complexity, distribution infrastructure 110 may include at least one physical processor 112 and at least one memory device 114. One or more modules 116 may be stored or loaded into memory 114 to enable adaptive streaming, as discussed herein.

Content player 120 generally represents any type or form of device or system capable of playing audio and/or video content that has been provided over distribution infrastructure 110. Examples of content player 120 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 110, content player 120 may include a physical processor 122, memory 124, and one or more modules 126. Some or all of the adaptive streaming processes described herein may be performed or enabled by modules 126, and in some examples, modules 116 of distribution infrastructure 110 may coordinate with modules 126 of content player 120 to provide adaptive streaming of multimedia content.

In certain embodiments, one or more of modules 116 and/or 126 in FIG. 1 may represent one or more software applications or programs that, when executed by a computing device, may cause the computing device to perform one or more tasks. For example, and as will be described in greater detail below, one or more of modules 116 and 126 may represent modules stored and configured to run on one or more general-purpose computing devices. One or more of modules 116 and 126 in FIG. 1 may also represent all or portions of one or more special-purpose computers configured to perform one or more tasks.

Physical processors 112 and 122 generally represent any type or form of hardware-implemented processing unit capable of interpreting and/or executing computer-readable instructions. In one example, physical processors 112 and 122 may access and/or modify one or more of modules 116 and 126, respectively. Additionally or alternatively, physical processors 112 and 122 may execute one or more of modules 116 and 126 to facilitate adaptive streaming of multimedia content. Examples of physical processors 112 and 122 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 114 and 124 generally represent any type or form of volatile or non-volatile storage device or medium capable of storing data and/or computer-readable instructions. In one example, memory 114 and/or 124 may store, load, and/or maintain one or more of modules 116 and 126. Examples of memory 114 and/or 124 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

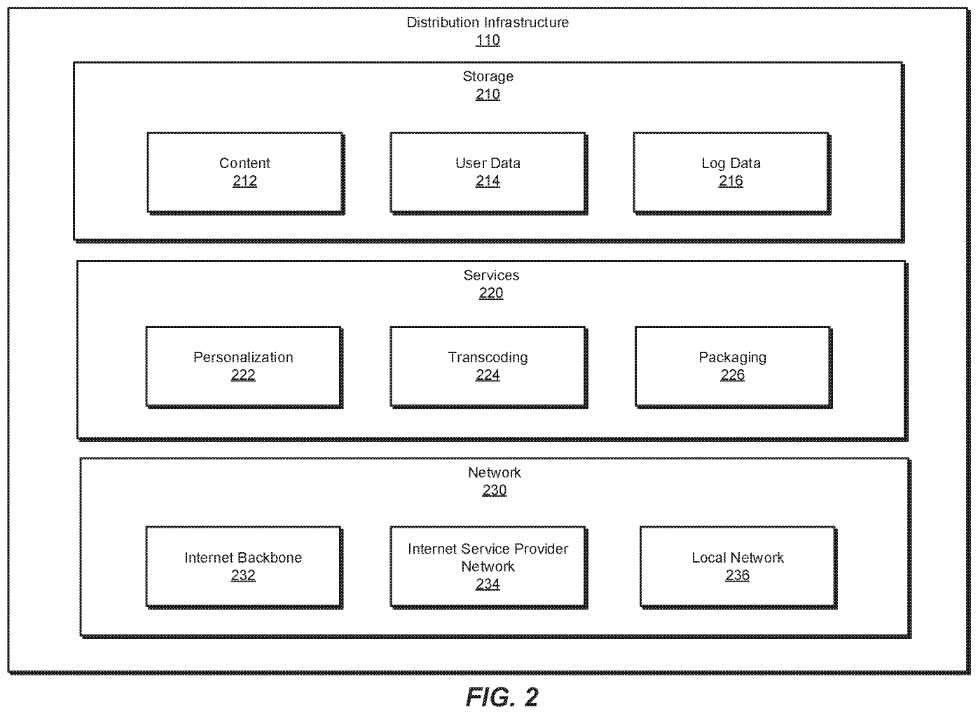

FIG. 2 is a block diagram of exemplary components of content distribution infrastructure 110 according to certain embodiments. Distribution infrastructure 110 may include storage 210, services 220, and a network 230. Storage 210 generally represents any device, set of devices, and/or systems capable of storing content for delivery to end users. Storage 210 may include a central repository with devices capable of storing terabytes or petabytes of data and/or may include distributed storage systems (e.g., appliances that mirror or cache content at Internet interconnect locations to provide faster access to the mirrored content within certain regions). Storage 210 may also be configured in any other suitable manner.

As shown, storage 210 may store, among other items, content 212, user data 214, and/or log data 216. Content 212 may include television shows, movies, video games, user-generated content, and/or any other suitable type or form of content. User data 214 may include personally identifiable information (PII), payment information, preference settings, language and accessibility settings, and/or any other information associated with a particular user or content player. Log data 216 may include viewing history information, network throughput information, and/or any other metrics associated with a user's connection to or interactions with distribution infrastructure 110.

Services 220 may include personalization services 222, transcoding services 224, and/or packaging services 226. Personalization services 222 may personalize recommendations, content streams, and/or other aspects of a user's experience with distribution infrastructure 110. Encoding services 224 may compress media at different bitrates which may enable real-time switching between different encodings. Packaging services 226 may package encoded video before deploying it to a delivery network, such as network 230, for streaming.

Network 230 generally represents any medium or architecture capable of facilitating communication or data transfer. Network 230 may facilitate communication or data transfer via transport protocols using wireless and/or wired connections. Examples of network 230 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 2, network 230 may include an Internet backbone 232, an internet service provider 234, and/or a local network 236.

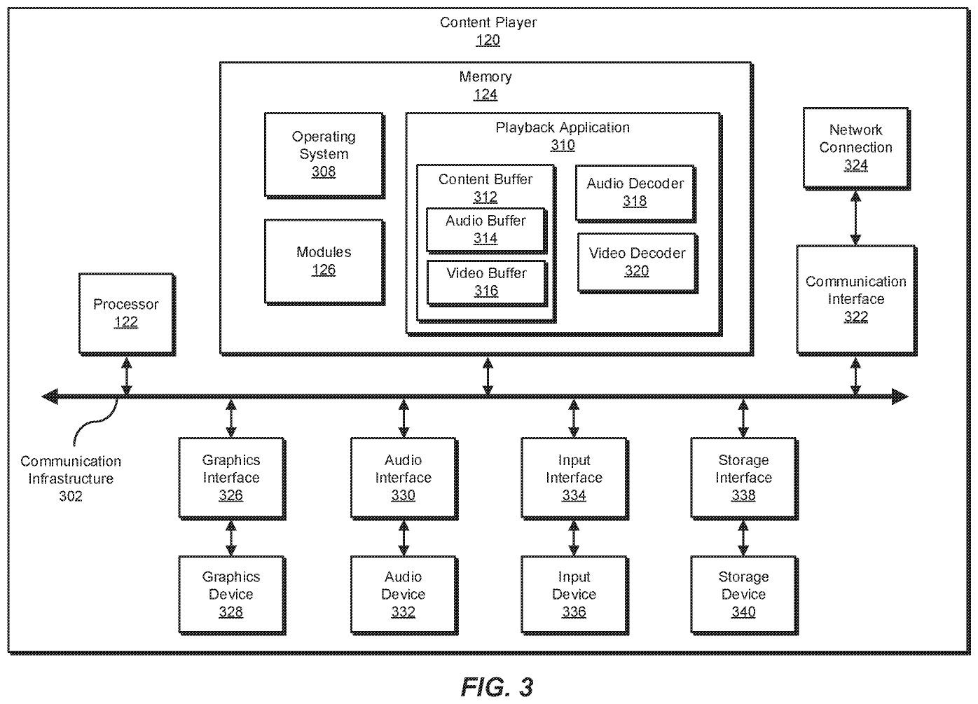

FIG. 3 is a block diagram of an exemplary implementation of content player 120 of FIG. 1. Content player 120 generally represents any type or form of computing device capable of reading computer-executable instructions. Content player 120 may include, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 3, in addition to processor 122 and memory 124, content player 120 may include a communication infrastructure 302 and a communication interface 322 coupled to a network connection 324. Content player 120 may also include a graphics interface 326 coupled to a graphics device 328, an input interface 334 coupled to an input device 336, and a storage interface 338 coupled to a storage device 340.

Communication infrastructure 302 generally represents any type or form of infrastructure capable of facilitating communication between one or more components of a computing device. Examples of communication infrastructure 302 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 124 generally represents any type or form of volatile or non-volatile storage device or medium capable of storing data and/or other computer-readable instructions. In some examples, memory 124 may store and/or load an operating system 308 for execution by processor 122. In one example, operating system 308 may include and/or represent software that manages computer hardware and software resources and/or provides common services to computer programs and/or applications on content player 120.

Operating system 308 may perform various system management functions, such as managing hardware components (e.g., graphics interface 326, audio interface 330, input interface 334, and/or storage interface 338). Operating system 308 may also process memory management models for playback application 310. The modules of playback application 310 may include, for example, a content buffer 312, an audio decoder 318, and a video decoder 320.

Playback application 310 may be configured to retrieve digital content via communication interface 322 and play the digital content through graphics interface 326. A video decoder 320 may read units of video data from video buffer 316 and may output the units of video data in a sequence of video frames corresponding in duration to the fixed span of playback time. Reading a unit of video data from video buffer 316 may effectively de-queue the unit of video data from video buffer 316. The sequence of video frames may then be rendered by graphics interface 326 and transmitted to graphics device 328 to be displayed to a user.

In situations where the bandwidth of distribution infrastructure 110 is limited and/or variable, playback application 310 may download and buffer consecutive portions of video data and/or audio data from video encodings with different bit rates based on a variety of factors (e.g., scene complexity, audio complexity, network bandwidth, device capabilities, etc.). In some embodiments, video playback quality may be prioritized over audio playback quality. Audio playback and video playback quality may also be balanced with each other, and in some embodiments audio playback quality may be prioritized over video playback quality.

Content player 120 may also include a storage device 340 coupled to communication infrastructure 302 via a storage interface 338. Storage device 340 generally represent any type or form of storage device or medium capable of storing data and/or other computer-readable instructions. For example, storage device 340 may be a magnetic disk drive, a solid-state drive, an optical disk drive, a flash drive, or the like. Storage interface 338 generally represents any type or form of interface or device for transferring data between storage device 340 and other components of content player 120.

Many other devices or subsystems may be included in or connected to content player 120. Conversely, one or more of the components and devices illustrated in FIG. 3 need not be present to practice the embodiments described and/or illustrated herein. The devices and subsystems referenced above may also be interconnected in different ways from that shown in FIG. 3. Content player 120 may also employ any number of software, firmware, and/or hardware configurations.

FIG. 4 is a flow diagram of an exemplary computer-implemented method 400 for adjusting application functionality to resource constraints. The steps shown in FIG. 4 may be performed by any suitable computer-executable code and/or computing system, including the systems illustrated in FIGS. 1-3 and an electronic device 500 in FIG. 5. One or more of the steps shown in FIG. 4 may also be initiated or performed by a remote system connected to a local system or device, such as by a server connected to electronic device 500. In one example, each of the steps shown in FIG. 4 may represent an algorithm whose structure includes and/or is represented by multiple sub-steps, examples of which will be provided in greater detail below.

As illustrated in FIG. 4, at step 410, one or more of the systems described herein may identify an application, on an electronic device, with a minimum requirement for a resource of the electronic device. For example, FIG. 5 is a block diagram of an exemplary electronic device 500 for adjusting application functionality to resource constraints. As illustrated in FIG. 5, an identification module 502 may identify an application 510 that has a minimum requirement 512 for a resource 516 of electronic device 500. Furthermore, although illustrated as part of electronic device 500 in FIG. 5, one or more of modules 502-508 may represent modules of a remote computing system that identifies resource constraints of electronic device 500 and/or selects modes for application 510 remotely.

In some embodiments, electronic device 500 may generally represent any type or form of computing device capable of capturing and/or transmitting video data. Examples of electronic device 500 may include, without limitation, laptops, tablets, desktops, servers, cellular phones, Personal Digital Assistants (PDAs), multimedia players, embedded systems, automotive audiovisual systems, wearable devices (e.g., smart watches, smart glasses, etc.), gaming consoles, combinations of one or more of the same, or any other suitable computing device. Additionally, electronic device 500 may include content player 120 in FIGS. 1 and 3 and/or various other components of FIGS. 1-2. In some examples, electronic device 500 may include a low-resource device, such as a feature phone or a low-cost tablet device, and/or any other computing device operating in a low-resource condition, such as a device with a low bandwidth or low battery capacity. For example, electronic device 500 may represent a mobile phone with a maximum RAM capacity of 1 gigabyte, which may struggle to run full-functionality applications.

As used herein, the term “application” generally refers to a software program designed to perform specific functions or tasks and capable of being installed, deployed, executed, and/or otherwise implemented on a computing system. Application 510 may include, without limitation, playback application 310 of FIG. 3, productivity software, enterprise software, entertainment software, security applications, cloud-based applications, web applications, mobile applications, content access software, simulation software, integrated software, application packages, application suites, variations or combinations of one or more of the same, and/or any other suitable software application.

The systems described herein may perform step 410 in a variety of ways. In one example, resource 516 may include a memory, a processing capacity, and/or a network connection. For example, resource 516 may include memory 124 and/or storage 210, processor 122 and/or services 220, network connection 324 and/or network 230, and/or other elements of FIGS. 1-3. Additionally, resource 516 may include Random Access Memory (RAM), Read Only Memory (ROM), disk drives, Central Processing Units (CPUs), Graphics Processing Units (GPUs), Video Processing Units (VPUs), layered memory caches, network caching, network request prioritization, and/or any other suitable resources or functions of a computing device.

In some examples, identification module 502 may identify application 510 based on determining that a user 520 is attempting to run application 510. In other examples, application 510 may already be running on electronic device 500, and identification module 502 may monitor the status and requirements of application 510.

Returning to FIG. 4, at step 420, one or more of the systems described herein may determine that an available amount of the resource of the electronic device does not meet the minimum requirement of the application. For example, as shown in FIG. 5, a determination module 504 may determine that an available amount 518 of resource 516 does not meet minimum requirement 512.

The systems described herein may perform step 420 in a variety of ways. In some embodiments, determination module 504 may determine that minimum requirement 512 exceeds a total capacity of resource 516. Additionally or alternatively, determination module 504 may determine minimum requirement 512 exceeds an unused portion of resource 516. For example, additional applications running on electronic device 500 may also use a portion of resource 516, and the currently available remaining portion is not enough to satisfy minimum requirement 512 of application 510. In additional embodiments, determination module 504 may determine the total capacity of resource 516 based on a device type of electronic device 500 and/or known attributes of electronic device 500. For example, electronic device 500 may represent a mobile device known to have a limited display resolution, and determination module 504 may determine the display resolution does not meet minimum requirement 512 based on identifying the device type of electronic device 500 and searching the device specifications of the particular device type.

Returning to FIG. 4, at step 430, one or more of the systems described herein may select, based on the determination, an alternative user-interface mode of the application with a lower minimum requirement for the resource. For example, as shown in FIG. 5, a selection module 506 may select an alternative user-interface mode 514 with a lower minimum requirement than minimum requirement 512.

The systems described herein may perform step 430 in a variety of ways. In some embodiments, the term “user-interface mode” may generally represent a graphical user interface (GUI) of an application with optional functions and graphical elements that may differ from another user-interface mode. For example, a user-interface mode may dictate the size of the application GUI, the functions available to a user and displayed in the GUI, animated or static graphical elements, or any other functions or elements that may vary between different modes of the same application. Additionally, user-interface modes may include different application profiles or application configurations that may be selected or altered based on different resource constraints and/or user input.

In one embodiment, selection module 506 may select an alternative user-interface mode 514 by selecting the mode based on a type of resource 516 that does not meet minimum requirement 512. In this embodiment, selection module 506 may determine tradeoffs between multiple alternative user-interface modes depending on which resources are constrained and the minimum requirements for each alternative user-interface mode. Additionally, selection module 506 may select an appropriate mode based on known constraints of the device type of electronic device 500. In other embodiments, selection module 506 may further select an alternative user-interface mode 514 to fulfill minimum requirements of application 510 for multiple resources of electronic device 500.

FIG. 6 illustrates resources 516(1)-(3) with current available amounts 518(1)-(3), respectively. As shown in this example, application 510 may include multiple alternative user-interface modes 514(1)-(3) with different minimum requirements 512(1)-(3), respectively, for memory and network resources corresponding to resource 516(1) and resource 516(3). In this example, based on available amount 518(1) of resource 516(1) (e.g., 42 MB) and available amount 518(3) of resource 516(3) (e.g., 128 Kbits/s), selection module 506 may select alternative user-interface mode 514(1) with minimum requirement 512(1) for memory and network resources that do not exceed the available amounts (e.g., 36 MB and 128 Kbits/s). In contrast, minimum requirement 512(2) of alternative user-interface mode 514(2) exceeds available network bandwidth (e.g., 192 Kbits/s) while minimum requirement 512(3) of alternative user-interface mode 514(3) exceeds available memory capacity (e.g., 97 MB). Thus, alternative user-interface mode 514(1) maximizes the potential functionality of application 510 to satisfy the current resource constraints.

In some examples, alternative user-interface mode 514 of FIG. 5 may include a mode prioritizing a function of application 510 to enable reducing a usage of resource 516 and/or deferring the usage of resource 516. In these examples, alternative user-interface mode 514 may simplify the function of application 510 to require less of resource 516 compared to a standard mode of application 510. Alternatively, alternative user-interface mode 514 may defer the function or partially defer the function until resource 516 is capable of handling the function. For example, alternative user-interface mode 514 may defer data fetching, defer the rendering of some graphical elements, reduce a resolution or size of an image, disable an animation in favor of a static graphic, or defer some other non-essential function in favor of ensuring the prioritized function may be fulfilled. Additionally, some functions and mode attributes, such as prefetching data or the size of data payloads, may not be directly viewable by the user despite affecting the operation of alternative user-interface mode 514.

In additional examples, prioritizing the function of application 510 may include optimizing a search speed, simplifying rendering of a user-interface element, decreasing a quality of a streaming element, decreasing a processing footprint on electronic device 500, decreasing a memory footprint on electronic device 500, decreasing a network usage, and/or delaying a non-essential component of the application. In other words, prioritizing the function of application 510 may include running a “lite” version of application 510 that prioritizes resource 516 to first fulfill core functions of application 510 before fulfilling optional functions.

For example, in the example of video streaming, alternative user-interface mode 514 may reduce the size of a standard video player to reduce resolution of the video. The reduced resolution may, in turn, reduce the required bandwidth for streaming a video, thereby reducing the required network resources for application 510. In this example, although the quality of the video may decrease, user 520 may still be able to stream and watch the video. Alternatively, user 520 may prefer to defer playing the video until bandwidth increases such that the video may be played at full resolution.

In one embodiment, the function of application 510 may include a search function. In this embodiment, optimizing the search speed may include reducing a number of predictive search results and/or reducing automation of a search completion function. For example, a standard search function of application 510 may automatically predict and display search results as user 520 types a search query. In this example, the search function may require more processing power to perform the search and update the search during typing. By reducing the number of results that are displayed or deferring the automation of predictive completion of a search query, alternative user-interface mode 514 may require a lower processing capacity to perform the search. Additionally, alternative user-interface mode 514 may require a lower memory footprint by reducing graphical elements that are displayed during the search query.

FIG. 7 illustrates a function 700, which may represent a search function, of application 510. In the example of FIG. 7, a standard user-interface mode 702 may include displaying search results as user 520 begins to type the query. Results may then be fully displayed after completion of the query. In contrast, selection module 506 may select alternative user-interface mode 514 that does not provide predictive search queries during typing. Instead, alternative user-interface mode 514 may wait to present all search results after typing is completed. Additionally, alternative user-interface mode 514 may only display a few search results at a time, requiring user 520 to browse paginated results, thereby simplifying the graphical user interface and reducing memory and processor requirements.

In an alternate example, alternative user-interface mode 514 may continue to provide some predictive search results during typing of the query, but user 520 may be required to manually select a result, such as by tapping a predictive result to complete the full search query. Additionally, in some examples, predictive results may be deferred until a predetermined amount of the query is typed, such as waiting for a certain number of characters to be typed before displaying predictive searches. In these examples, using fewer characters may be determined to be less useful in accurately predicting the search query and, therefore, may be considered a non-essential function.

In one embodiment, the function of application 510 may include the rendering of user-interface or graphical elements. In this embodiment, simplifying rendering of a user-interface element may include decreasing a size of the user-interface element, reducing an amount of detail presented in the user-interface element, and/or deferring rendering of the user-interface element. For example, animated elements may be reduced to static images or animated with lower frame rates. In some embodiments, graphical elements or details may be partially loaded and displayed, rather than the full details as a standard. Additionally, a user interface of application 510 may also be simplified by eliminating graphical elements that are less important to user experience.

In some embodiments, graphical elements may be determined to be less important to user experience based on the functions of application 510. For example, elements that enable user 520 to browse a selection of videos, such as titles of movies or box art images, may be determined to be important, while elements that provide in-depth details, such as synopses or cast lists, may be determined to be less important to the function of browsing. In these embodiments, alternative user-interface mode 514 may not include rendering of these less important elements or may decrease the size or detail of the elements for faster rendering. In other embodiments, elements may be ranked by importance and rendered in order of ranking, based on available resources. For example, selection module 506 may select alternative user-interface mode 514, which may include the highest ranked elements, based on current resources and/or capabilities of electronic device 500. For devices with different resources and/or capabilities, different elements may be included in or stripped out of alternative user-interface mode 514 based on the preferred functions of application 510 and/or based on the resources or capabilities of the device.

For example, FIG. 8 illustrates a function 800, which may represent user interface rendering, of application 510. In this example, alternative user-interface mode 514 may include a user-interface element 802(1) that is rendered with a smaller size and resolution in comparison to a user-interface element 802(2) in standard user-interface mode 702. Additionally, alternative user-interface mode 514 may display fewer details about a video, such as by eliminating a non-essential component 804 of standard user-interface mode 702. In this example, non-essential component 804 may be deemed less important for user 520 to use in selecting a video in comparison to user-interface element 802(1). Thus, user 520 may continue to be able to find the relevant video with a simpler user interface with reduced features.

In some examples, selection module 506 of FIG. 5 may select alternative user-interface mode 514 of application 510 based on a user preference 522 for a function of application 510. In these examples, user preference 522 may be preselected by user 520 or determined by application 510 based on user behavior or use of application 510. Additionally or alternatively, selection module 506 may request confirmation for alternative user-interface mode 514 from user 520 and receives a response from user 520. In this example, the response may include a confirmation of alternative user-interface mode 514 or a rejection of alternative user-interface mode 514. Additionally, selection module 506 may select a different alternative user-interface mode of application 510 based on a rejection of alternative user-interface mode 514.

As illustrated in FIG. 9, user 520 may send a response 902 to reject alternative user-interface mode 514(1), which may be initially selected by selection module 506. For example, selection module 506 may present a pop-up window informing user 520 of limited resources and a need to select a mode using less resources. In this example, user 520 may then respond to enter or select a preferred mode or to reject a mode presented by the window. For a rejection of alternative user-interface mode 514(1), selection module 506 may then select alternative user-interface mode 514(2) based on response 902 and/or user preference 522 of FIG. 5.

In some embodiments, user 520 may initially select alternative user-interface mode 514(1) or alternative user-interface mode 514(2) as the initial startup mode of application 510. As in the above video streaming example, user 520 may prefer to defer playing the video until bandwidth increases such that the video may be played at full resolution, thereby preferring to defer video streaming rather than optimizing streaming for available resources. Additionally or alternatively, the mode of application 510 may be dynamically changed based on real-time updates of resource constraints. For example, in a dynamic resource system with fluctuating resource availability, the mode of application 510 may change without requiring a user selection.

Returning to FIG. 4, at step 440, one or more of the systems described herein may instantiate the alternative user-interface mode of the application. For example, as shown in FIG. 5, an instantiation module 508 may instantiate alternative user-interface mode 514.

The systems described herein may perform step 440 in a variety of ways. In one example, instantiation module 508 may instantiate alternative user-interface mode 514 by initiating application 510 in alternative user-interface mode 514. Alternatively, instantiation module 508 may transition to alternative user-interface mode 514 based on determining that a decrease in available amount 518 of resource 516 results in resource 516 not meeting minimum requirement 512 of application 510. For example, as shown in FIG. 7, standard user-interface mode 702 may be switched to alternative user-interface mode 514 if available processor capacity decreases such that full search functionality is not possible. In some examples, resource 516 may be a static resource, and available amount 518 of resource 516 may fluctuate based on usage by various applications and functions. Alternatively, resource 516 may be a dynamic, load-based resource that fluctuates to accommodate usage.

The above described systems may further include determining that available amount 518 of resource 516 meets minimum requirement 512 of application 510. In this example, the described systems may then instantiate a standard user-interface mode, such as standard user-interface mode 702 of FIG. 8, based on the determination. In this example, standard user-interface mode 702 may include a mode capable of maximizing a function of application 510 by increasing a usage of resource 516 and/or or resuming the usage of resource 516. Additionally, the above described systems may instantiate standard user-interface mode 702 by initiating application 510 in standard user-interface mode 702 or transitioning to standard user-interface mode 702 based on determining that an increase in available amount 518 of resource 516 results in resource 516 meeting minimum requirement 512. For example, standard user-interface mode 702 of FIG. 8 may resume displaying non-essential component 804 after determining available GPU resources have increased. Alternatively, the described systems may start application 510 in standard user-interface mode 702 if available amount 518 meets minimum requirement 512 of standard user-interface mode 702.

In some examples, the above described systems may further include determining an available amount of a different resource of electronic device 500 does not meet a minimum requirement for the different resource and, subsequently, transitioning to a different alternative user-interface mode of the application with a lower minimum requirement for the different resource. For example, the described systems may initially select alternative user-interface mode 514(2) of FIG. 6 due to low memory requirements. However, user 520 may then require a network to perform additional functions, such as video streaming, and the described systems may then transition from alternative user-interface mode 514(2) to alternative user-interface mode 514(1) to also satisfy network requirements. In other examples, the described systems may transition between user-interface modes based on changing resource constraints to dynamically select and instantiate a mode with the maximum functionality possible based on the constraints.

As explained above in connection with method 400 in FIG. 4, the disclosed systems and methods may, by determining current constraints on the resources of a computing device, select an appropriate mode to run an application. Specifically, the disclosed systems and methods may first determine that the minimum requirements to run a standard mode of the application are not met by existing availability of resources. The disclosed systems and methods may then select an alternative user-interface mode to preferentially ensure a function of the application is available based on the constrained resources. For example, the systems and methods described herein may limit some search functions or graphical elements to ensure a user is able to continue completing a search query. The disclosed systems and methods may also dynamically switch to the alternative user-interface modes when an available amount of a resource decreases.

Additionally, the systems and methods described herein may select modes based on user preferences for some functions over other functions. For example, the disclosed systems and methods may defer video streaming if a user prefers to wait for higher network bandwidth rather than to view lower resolution videos. The systems and methods described herein may also optionally switch to modes with more functionality requiring higher amounts of resources when those resources become available. In some examples, the disclosed systems and methods may also apply mode selection to content delivery network (CDN) resourcing, based on the available resources of endpoint devices. By implementing multiple user-interface modes in a single application, the disclosed systems and methods may more easily transition between different modes in response to changes in resource constraints. Thus, the systems and methods described herein may dynamically improve the functionality of an application to maximize the capabilities of the application based on available resources.

### Example Embodiments

1. A computer-implemented method comprising: identifying an application, on an electronic device, with a minimum requirement for a resource of the electronic device; determining that an available amount of the resource of the electronic device does not meet the minimum requirement of the application; selecting, based on the determination, an alternative user-interface mode of the application with a lower minimum requirement for the resource; and instantiating the alternative user-interface mode of the application.

2. The method of claim 1, wherein the resource of the electronic device comprises at least one of: a memory, a processing capacity, and/or a network connection.

3. The method of claim 1, wherein determining that the available amount of the resource does not meet the minimum requirement comprises determining that the minimum requirement exceeds at least one of: a total capacity of the resource and/or an unused portion of the resource.

4. The method of claim 1, wherein the alternative user-interface mode comprises a mode prioritizing a function of the application to enable at least one of: reducing a usage of the resource and/or deferring the usage of the resource.

5. The method of claim 4, wherein selecting the alternative user-interface mode of the application comprises selecting the mode based on a type of the resource that does not meet the minimum requirement.

6. The method of claim 4, wherein prioritizing the function of the application comprises at least one of: optimizing a search speed, simplifying rendering of a user-interface element, decreasing a quality of a streaming element, decreasing a processing footprint on the electronic device, decreasing a memory footprint on the electronic device, decreasing a network usage, and/or delaying a non-essential component of the application.

7. The method of claim 6, wherein optimizing the search speed comprises at least one of: reducing a number of predictive search results and/or reducing automation of a search completion function.

8. The method of claim 6, wherein simplifying rendering of a user-interface element comprises at least one of: decreasing a size of the user-interface element, reducing an amount of detail presented in the user-interface element, and/or deferring rendering of the user-interface element.

9. The method of claim 1, wherein instantiating the alternative user-interface mode of the application comprises at least one of: initiating the application in the alternative user-interface mode and/or transitioning to the alternative user-interface mode based on determining that a decrease in the available amount of the resource does not meet the minimum requirement of the application.

10. The method of claim 1, further comprising determining that the available amount of the resource of the electronic device meets the minimum requirement of the application and instantiating a standard user-interface mode of the application based on the determination.

11. The method of claim 10, wherein the standard user-interface mode comprises a mode capable of maximizing a function of the application by at least one of: increasing a usage of the resource and/or resuming the usage of the resource.

12. The method of claim 10, wherein instantiating the standard user-interface mode of the application comprises at least one of: initiating the application in the standard user-interface mode and/or transitioning to the standard user-interface mode based on determining that an increase in the available amount of the resource meets the minimum requirement of the application.

13. The method of claim 1, further comprising determining an available amount of a different resource of the electronic device does not meet a minimum requirement for the different resource and transitioning to a different alternative user-interface mode of the application with a lower minimum requirement for the different resource.

14. A system comprising: an identification module, stored in memory, that identifies an application, on an electronic device, with a minimum requirement for a resource of the electronic device; a determination module, stored in memory, that determines that an available amount of the resource of the electronic device does not meet the minimum requirement of the application; a selection module, stored in memory, that selects, based on the determination, an alternative user-interface mode of the application with a lower minimum requirement for the resource; an instantiation module, stored in memory, that instantiates the alternative user-interface mode of the application; and at least one processor that executes the identification module, the determination module, the selection module, and the instantiation module.

15. The system of claim 14, wherein the selection module selects the alternative user-interface mode of the application based on a user preference for a function of the application.

16. The system of claim 14, wherein the selection module requests confirmation for the alternative user-interface mode from a user of the electronic device and receives a response from the user.

17. The system of claim 16, wherein the response from the user comprises at least one of: a confirmation of the alternative user-interface mode or a rejection of the alternative user-interface mode.

18. The system of claim 17, wherein the selection module selects a different alternative user-interface mode of the application based on the rejection of the alternative user-interface mode.

19. The system of claim 14, wherein the selection module further selects the alternative user-interface mode to fulfill minimum requirements of the application for multiple resources of the electronic device.

20. A computer-readable medium comprising one or more computer-executable instructions that, when executed by at least one processor of a computing device, cause the computing device to: identify an application, on an electronic device, with a minimum requirement for a resource of the electronic device; determine that an available amount of the resource of the electronic device does not meet the minimum requirement of the application; select, based on the determination, an alternative user-interface mode of the application with a lower minimum requirement for the resource; and instantiate the alternative user-interface mode of the application.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive resource availability data to be transformed, transform the resource availability data, output a result of the transformation to compare with an application's minimum requirement, use the result of the transformation to select an alternative user-interface mode of the application, and store the result of the transformation to instantiate the alternative user-interface mode. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
identifying an application, on an electronic device, with a minimum requirement for a resource of the electronic device;
determining that an available amount of the resource of the electronic device does not meet the minimum requirement of the application;
selecting, based on the determination, an alternative user-interface mode of the application with a lower minimum requirement for the resource; and
instantiating the alternative user-interface mode of the application.

2. The method of claim 1, wherein the resource of the electronic device comprises at least one of:
a memory;
a processing capacity; or
a network connection.

3. The method of claim 1, wherein determining that the available amount of the resource does not meet the minimum requirement comprises determining that the minimum requirement exceeds at least one of:
a total capacity of the resource; or
an unused portion of the resource.

4. The method of claim 1, wherein the alternative user-interface mode comprises a mode prioritizing a function of the application to enable at least one of:
reducing a usage of the resource; or
deferring the usage of the resource.

5. The method of claim 4, wherein selecting the alternative user-interface mode of the application comprises selecting the mode based on a type of the resource that does not meet the minimum requirement.

6. The method of claim 4, wherein prioritizing the function of the application comprises at least one of:
optimizing a search speed;
simplifying rendering of a user-interface element;
decreasing a quality of a streaming element;
decreasing a processing footprint on the electronic device;
decreasing a memory footprint on the electronic device;
decreasing a network usage; or
delaying a non-essential component of the application.

7. The method of claim 6, wherein optimizing the search speed comprises at least one of:
reducing a number of predictive search results; or
reducing automation of a search completion function.

8. The method of claim 6, wherein simplifying rendering of a user-interface element comprises at least one of:
decreasing a size of the user-interface element;
reducing an amount of detail presented in the user-interface element; or
deferring rendering of the user-interface element.

9. The method of claim 1, wherein instantiating the alternative user-interface mode of the application comprises at least one of:
initiating the application in the alternative user-interface mode; or
transitioning to the alternative user-interface mode based on determining that a decrease in the available amount of the resource does not meet the minimum requirement of the application.

10. The method of claim 1, further comprising:
determining that the available amount of the resource of the electronic device meets the minimum requirement of the application; and
instantiating a standard user-interface mode of the application based on the determination.

11. The method of claim 10, wherein the standard user-interface mode comprises a mode capable of maximizing a function of the application by at least one of:
increasing a usage of the resource; or
resuming the usage of the resource.

12. The method of claim 10, wherein instantiating the standard user-interface mode of the application comprises at least one of:
initiating the application in the standard user-interface mode; or
transitioning to the standard user-interface mode based on determining that an increase in the available amount of the resource meets the minimum requirement of the application.

13. The method of claim 1, further comprising:
determining an available amount of a different resource of the electronic device does not meet a minimum requirement for the different resource; and
transitioning to a different alternative user-interface mode of the application with a lower minimum requirement for the different resource.

14. A system comprising:
an identification module, stored in memory, that identifies an application, on an electronic device, with a minimum requirement for a resource of the electronic device;
a determination module, stored in memory, that determines that an available amount of the resource of the electronic device does not meet the minimum requirement of the application;
a selection module, stored in memory, that selects, based on the determination, an alternative user-interface mode of the application with a lower minimum requirement for the resource;
an instantiation module, stored in memory, that instantiates the alternative user-interface mode of the application; and
at least one processor that executes the identification module, the determination module, the selection module, and the instantiation module.

15. The system of claim 14, wherein the selection module selects the alternative user-interface mode of the application based on a user preference for a function of the application.

16. The system of claim 14, wherein the selection module:
requests confirmation for the alternative user-interface mode from a user of the electronic device; and
receives a response from the user.

17. The system of claim 16, wherein the response from the user comprises at least one of:
a confirmation of the alternative user-interface mode; or
a rejection of the alternative user-interface mode.

18. The system of claim 17, wherein the selection module selects a different alternative user-interface mode of the application based on the rejection of the alternative user-interface mode.

19. The system of claim 14, wherein the selection module further selects the alternative user-interface mode to fulfill minimum requirements of the application for multiple resources of the electronic device.

20. A computer-readable medium comprising one or more computer-executable instructions that, when executed by at least one processor of a computing device, cause the computing device to:
identify an application, on an electronic device, with a minimum requirement for a resource of the electronic device;
determine that an available amount of the resource of the electronic device does not meet the minimum requirement of the application;
select, based on the determination, an alternative user-interface mode of the application with a lower minimum requirement for the resource; and
instantiate the alternative user-interface mode of the application.
